(19) United States
(12) Patent Application Publication
(10) Pub. No.: US 2008/0257215 A1
(43) Pub. Date: Oct. 23, 2008

(54) Coatings for media

(76) Inventor: Molly L. Hladik, Monmouth, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/788,906

(22) Filed: Apr. 23, 2007

(51) Int. Cl. G02B 1/10

(52) U.S. Cl. 106/287.23

(57) ABSTRACT

Coating layers, image recording media, methods of preparing image recording media, and the like, are disclosed.

### BACKGROUND

Compositions that produce a color change upon exposure to energy in the form of light are of great interest in producing images on a variety of substrates. For example, labeling of optical storage media such as Compact Discs, Digital Video Discs, or Blue Laser Discs (CD, DVD, or Blue Laser Disc) can be routinely accomplished through screen-printing methods. While this method can provide a wide variety of label content, it tends to be cost ineffective for run lengths less than 300-400 discs because the fixed cost of unique materials and set-up are shared by all the discs in each run. In screen-printing, a stencil of the image is prepared, placed in contact with the disc, and then ink is spread by squeegee across the stencil surface. Where there are openings in the stencil the ink passes through to the surface of the disc, thus producing the image. Preparation of the stencil can be an elaborate, time-consuming, and expensive process.

In recent years, significant increases in use of CD/DVD discs as a data distribution vehicle have increased the need to provide customized label content to reflect the data content of the disc. For these applications, the screen-label printing presents a dilemma as discs are designed to permit customized user information to be recorded in standardized CD, DVD, or Blue Laser Disc formats. Today, for labeling small quantities of discs, popular methods include hand labeling with a permanent marker pen, using an inkjet printer to print an adhesive paper label, and printing directly with a pen on the disc media, which has a coating that has the ability to absorb inks. The hand printing methods do not provide high quality, and aligning a separately printed label by hand is inexact and difficult.

It may therefore be desirable to design an optical data recording medium (e.g., CD, DVD, or Blue Laser Disc) which can be individually labeled by the user easily and inexpensively relative to screen-printing, while giving a high quality label solution.

### SUMMARY

Briefly described, embodiments of this disclosure include coating layers, image recording media, methods of preparing image recording media, and the like. One exemplary embodiment of a coating layer, among others, includes: a UV curable free radical matrix, a thermal radical initiator, a color former, an activator, and a radiation-absorbing compound.

One exemplary embodiment of an image recording medium, among others, includes: a substrate having a coating layer disposed thereon, wherein the coating layer includes: a UV curable free radical matrix, a thermal radical initiator, a color former, an activator, and a radiation-absorbing compound.

One exemplary embodiment of method for preparing an image recording medium, among others, includes: providing a UV curable free radical matrix, a thermal radical initiator, a color former, an activator, and a radiation-absorbing compound; mixing the matrix, the thermal radical initiator, the radiation absorbing compound, the activator, and the color former to form a direct imaging material; and disposing the direct imaging material onto a substrate.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of an imaging medium.

FIG. 2 illustrates a representative embodiment of a print system.

### DETAILED DESCRIPTION

Embodiments of the present disclosure will employ, unless otherwise indicated, techniques of synthetic organic chemistry, ink chemistry, media chemistry, and the like, that are within the skill of the art. Such techniques are explained fully in the literature.

The following examples are put forth so as to provide those of ordinary skill in the art with a complete disclosure and description of how to perform the methods and use the compositions disclosed and claimed herein. Efforts have been made to ensure accuracy with respect to numbers (e.g., amounts, temperature, etc.) but some errors and deviations should be accounted for. Unless indicated otherwise, parts are parts by weight, temperature is in OC, and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the term “leuco-dye” means a color-forming substance that is colorless or of a first color in a non-activated state, and subsequently exhibits color or changes from the first color to a second color in an activated state.

As used herein, the term “activator” is a substance, that reacts with a leuco-dye, causing the leuco-dye to alter its chemical structure and change or acquire color. By way of example only, activators may be phenolic or other proton-donating species that can effect this change.

As used herein, the term “antenna” is a radiation-absorbing compound. The antenna readily absorbs a desired specific wavelength of the marking radiation.

### Discussion

Coating layers and substrates including coating layers are disclosed. The coating layer includes, but is not limited to, a matrix, a thermal radical initiator, a color former, an activator, and a radiation-absorbing compound. The thermal radical initiator can be decomposed when the radiation-absorbing compound absorbs radiation energy and heats the area adjacent the radiation-absorbing compound. The thermal radical initiator can initiate cross-linking of the polymers of the matrix when the thermal radical initiator is decomposed. Thus, the generation of the heat causes cross-linking of the polymers as well as causes a mark to be formed by a reaction between the activator and the color former.

Embodiments of the present disclosure allow for the write time to be decreased while maintaining or increasing the reliability of the image formation. Using previous technology required a trade off between write time and reliability. In short, a harder matrix (e.g., polymers in the matrix were cross-linked) required a longer write time but produced acceptable reliability, while a softer matrix (e.g., polymer in the matrix are not cross-linked) reduces write time but also reduces reliability. Embodiments of the present disclosure enable fast write times while maintaining or increasing reliability. In general, the matrix is initially softer (incomplete curing of the multifunctional monomers, and thus a lower Tg) but hardens when the coating layer is exposed to the radiation energy for writing to the coating layer (further cures the multifunctional monomers and increases Tg). In other words, the heat produced by the absorption of the radiation energy causes the decomposition of the thermal radical initiator that causes cross-linking of the polymers (hardening of the matrix).

For example, a clear mark and excellent image quality can be obtained by directing radiation energy (e.g., a 780 nm laser operating at 35 MW) at areas of the coating layer on which a mark is desired. As mentioned above, the components in the coating layer used to produce the mark via a color change upon stimulation by energy can include, but is not limited to, a matrix, a thermal radical initiator, a color former, an activator, and a radiation-absorbing compound. One or more of the components can be dissolved into a matrix material. When the radiation-absorbing compound absorbs radiation energy at a certain wavelength, it initiates a reaction between the color former and the activator to produce a color change (e.g., a mark). In addition, the heat generated by the absorption of the radiation energy causes the thermal radical initiator to decompose, which causes cross-linking of the polymers of the matrix material.

The radiation energy absorber functions to absorb radiation energy, convert the energy into heat, and deliver the heat to the reactants (e.g., the color former, the activator, and the thermal radical initiator). The radiation energy may then be applied by way of an infrared laser. Upon application of the radiation energy, the color former, the activator, and the thermal radical initiator may become heated and mix. As a result the color former becomes activated and causes a mark (color) to be produced. In addition, the thermal radical initiator causes polymer cross-linking in the matrix.

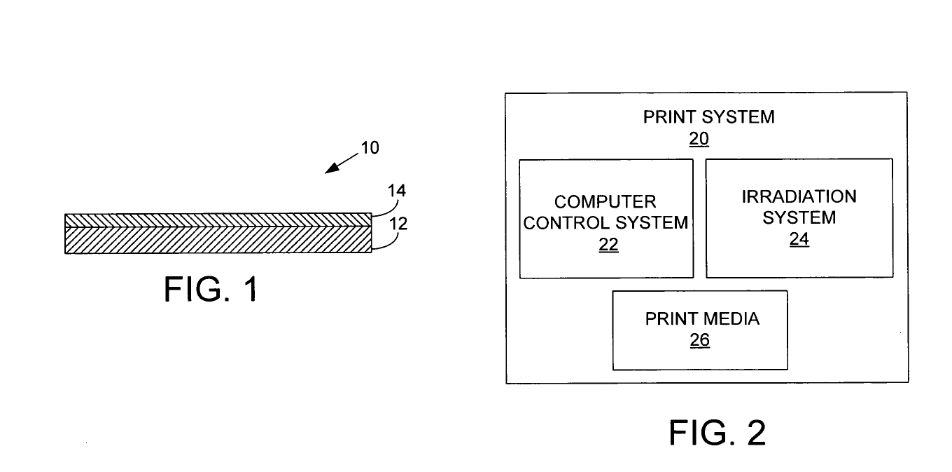

FIG. 1 illustrates an embodiment of an imaging medium 10. The imaging medium 10 can include, but is not limited to, a substrate 12 and a coating layer 14. The substrate 12 can be a substrate upon which it is desirable to make a mark, such as, but not limited to, paper (e.g., labels, tickets, receipts, or stationery), overhead transparencies, a metal/metal composite, glass, a ceramic, a polymer, and a labeling medium (e.g., a compact disk (CD) (e.g., CD-R/RW/ROM) and a digital video disk (DVD) (e.g., DVD-R/RW/ROM)).

In particular, the substrate 12 includes an “optical disk” which is meant to encompass audio, video, multi-media, and/or software disks that are machine readable in a CD and/or DVD drive, or the like. Examples of optical disk formats include writeable, recordable, and rewriteable disks such as DVD-HD, Blu-ray, DVD, DVD-R, DVD-RW, DVD+R, DVD+RW, DVD-RAM, CD, CD-ROM, CD-R, CD-RW, and the like. Other like formats can also be included, such as similar formats and formats to be developed in the future.

The coating layer 14 can include, but is not limited to, the matrix, the thermal radical initiator, the color former, the activator, the radiation-absorbing compound, as well as other components typically found in the particular media to be produced.

The layer 14 may be applied to the substrate 12 via any acceptable method, such as, but not limited to, rolling, spraying, and screen-printing. In addition, one or more layers can be formed between the layer 14 and the substrate 12 and/or one or more layer can be formed on top of the coating layer 14. In one embodiment, the layer 14 is part of a CD or a DVD.

To form a mark, radiation energy is directed imagewise at one or more discrete areas of the layer 14 of the imaging medium 10. The form of radiation energy may vary depending upon the equipment available, ambient conditions, the desired result, and the like. The radiation energy can include, but is not limited to, infrared (IR) radiation, ultraviolet (UV) radiation, x-rays, and visible light. The radiation-absorbing compound absorbs the radiation energy and heats the area of the layer 14 to which the radiation energy impacts. The heat may cause the color former and the activator to mix. The color former and the activator may then react to form a mark (color) on certain areas of the layer 14. In addition, the thermal radical initiator decomposes and causes polymer cross-linking.

FIG. 2 illustrates a representative embodiment of a print system 20. The print system 20 can include, but is not limited to, a computer control system 22, an irradiation system 24, and print media 26 (e.g., imaging medium). The computer control system 22 is operative to control the irradiation system 24 to cause marks (e.g., printing of characters, symbols, photos, and the like) to be formed on the print media 26. The irradiation system 24 can include, but is not limited to, a laser system, UV energy system, IR energy system, visible energy system, x-ray system, and other systems that can produce radiation energy to cause a mark to be formed on the layer 14. The print system 20 can include, but is not limited to, a laser printer system and an ink-jet printer system. In addition, the print system 20 can be incorporated into a digital media system. For example, the print system 20 can be operated in a digital media system to print labels (e.g., the layer is incorporated into a label) onto digital media such as CDs and DVDs. Furthermore, the print system 20 can be operated in a digital media system to directly print onto the digital media (e.g., the layer is incorporated the structure of the digital media).

As mentioned above, the coating layer includes, but is not limited to, the matrix, the thermal radical initiator, the color former, the activator, and the radiation-absorbing compound.

The thermal radical initiator can include compounds that decompose at temperatures of about 40 to 110° C., about 50 to 110° C., and about 60 to 110° C., and are soluble in the matrix. The thermal radical initiator can include, but is not limited to, azo compounds and peroxide compounds (with and without accelerators). The azo compounds can include compounds such as, but not limited to, 2,2′-azo (bisisobutyronitrile) and 1,1′-diphenyl-1,1′-diacetoxyazoethane. The peroxide compounds can include compounds such as, but not limited to, diacyl peroxides (e.g., dibenzoyl peroxide and di-tert-butyl peroxide), alkyl hydroperoxides, and their esters, peroxyesters, and persulfates. The radical initiators can be mixed with accelerator compounds (e.g., amines) and reducing agents (e.g., Fe(II), Ag, and Cu(II)) to produce the radical complexes used in the polymerization.

The thermal radical initiator is about 1 wt % to 10 wt % of the coating layer, about 3 wt % to 10 wt % of the coating layer, about 1 wt % to 7 wt % of the coating layer, about 1 wt % to 5 wt % of the coating layer, about 2 wt % to 10 wt % of the coating layer, and about 3 wt % to 5 wt % of the coating layer.

The matrix can include compounds capable of and suitable for dissolving and/or dispersing the radiation absorbing compound, the aromatic compound, the activator, and/or the color former. The matrix can include a UV curable free radical matrix. The matrix can include, but is not limited to, UV curable monomers, oligomers, and pre-polymers (e.g., acrylate derivatives. Illustrative examples of UV-curable monomers, oligomers, and pre-polymers (that may be mixed to form a suitable UV-curable matrix) can include but are not limited to, hexamethylene diacrylate, tripropylene glycol diacrylate, lauryl acrylate, isodecyl acrylate, neopentyl glycol diacrylate, 2-phenoxyethyl acrylate, 2(2-ethoxy)ethylacrylate, polyethylene glycol diacrylate and other acrylated polyols, trimethylolpropane triacrylate, pentaerythritol tetraacrylate, ethoxylated bisphenol A diacrylate, acrylic oligomers with epoxy functionality, and the like.

In an embodiment the matrix is used in combination with a photo package. A photo package may include, but is not limited to, a light absorbing species, which initiates reactions for curing of a matrix such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types, and the like.

It may be desirable to choose a matrix that is cured by a form of radiation other than the type of radiation that causes a color change. Matrices based on cationic polymerization resins may include photo-initiators based on aromatic diazonium salts, aromatic halonium salts, aromatic sulfonium salts and metallocene compounds, for example. An example of a matrix may include Nor-Cote CDG000. Other acceptable matrices may include, but is not limited to, acrylated polyester oligomers (e.g., CN293 and CN294, available from Sartomer Co.).

The matrix compound is about 2 wt % to 98 wt % of the coating layer and about 20 wt % to 90 wt % of the coating layer.

The term “color former” is a color forming substance, which is colorless or one color in a non-activated state and produces or changes color in an activated state. The color former can include, but is not limited to, leuco dyes and phthalide color formers (e.g., fluoran leuco dyes and phthalide color formers as described in “The Chemistry and Applications of Leuco Dyes”, Muthyala, Ramiah, ed., Plenum Press (1997) (ISBN 0-306-45459-9), which is incorporated herein by reference).

The color forming composition can include, but is not limited to, a wide variety of leuco dyes. Suitable leuco dyes include, but are not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)-4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)-4,5-diphenylimidazoles, phenethylanilines, phthalocyanine precursors (such as those available from Sitaram Chemicals, India), and other known leuco dye compositions. Experimental testing has shown that fluoran based dyes are one class of leuco dyes which exhibit particularly desirable properties.

In one aspect of the present disclosure, the leuco dye can be a fluoran, phthalide, aminotriarylmethane, or mixture thereof. Several non-limiting examples of suitable fluoran based leuco dyes include 3-diethylamino-6-methyl-7-anilinofluorane, 3-(N-ethyl-p-toluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofuranone,4,5,6,7-t-etrachloro-3,3-bis[2-[4-(dimethylamino)phenyl]-2-(4-methoxyphenyl)ethenyl]-, 2-anilino-3-methyl-6-(N-ethyl-N-isoamylamino)fluorane (S-205 available from Nagase Co., Ltd), and mixtures thereof.

Suitable aminotriarylmethane leuco dyes can also be used in the present invention, such as tris(N,N-dimethylaminophenyl)methane (LCV), tris(N,N-diethylaminophenyl)methane (LECV), tris(N,N-di-n-propylaminophenyl)methane (LPCV), tris(N,N-di-n-butylaminophenyl)methane (LBCV), bis(4-diethylaminophenyl)-1-(4-diethylamino-2-methyl-phenyl)methane (LV-1), bis(4-diethylamino-2-methylphenyl)-(4-diethylamino-phenyl)methane (LV-2), tris(4-diethylamino-2-methylphenyl)methane (LV-3), bis(4-diethylamino-2-methylphenyl)(3,4-dimethoxyphenyl)methane (LB-8), aminotriarylmethane leuco dyes having different alkyl substituents bonded to the amino moieties wherein each alkyl group is independently selected from C₁-C₄ alkyl, and aminotriaryl methane leuco dyes with any of the preceding named structures that are further substituted with one or more alkyl groups on the aryl rings wherein the latter alkyl groups are independently selected from C₁-C₃ alkyl. Other leuco dyes can also be used in connection with the present invention and are known to those skilled in the art. A more detailed discussion of some of these types of leuco dyes may be found in U.S. Pat. Nos. 3,658,543 and 6,251,571, each of which are hereby incorporated by reference in their entireties. Additional examples and methods of forming such compounds can be found in Chemistry and Applications of Leuco Dyes, Muthyala, Ramaiha, ed., Plenum Press, New York, London, ISBN: 0-306-45459-9, which is hereby incorporated by reference.

The color former can be about 3 wt % to 35 wt % of the coating layer, about 10 wt % to 30 wt % of the coating layer, and about 10 wt % to 20 wt % of the coating layer.

The term “radiation absorbing compound” (e.g., an antenna) means any radiation absorbing compound in which the antenna readily absorbs a desired specific wavelength of the marking radiation. The radiation absorbing compound can include dye radiation absorbing compounds and pigment radiation absorbing compounds. The radiation absorbing compound may be a material that effectively absorbs the type of energy to be applied to the print substrate 16 to effect a mark or color change. The radiation absorbing compound can include, but is not limited to, IR780 (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9Cl)); IR783 (Aldrich 54,329-2) (2) (2-[2-[2-Chloro-3-[2-[1,3-dihydro-3,3-dimethyl-1-(4-sulfobutyl)-2H-indol-2-ylidene]-ethylidene]-1-cyclohexen-1-yl]-ethenyl]-3,3-dimethyl-1-(4-sulfobutyl)-3H-indolium hydroxide, inner salt sodium salt); Syntec 9/1 (3)); Syntec 9/3 (4); or metal complexes (e.g., dithiolane metal complexes (5) and indoaniline metal complexes (6)).

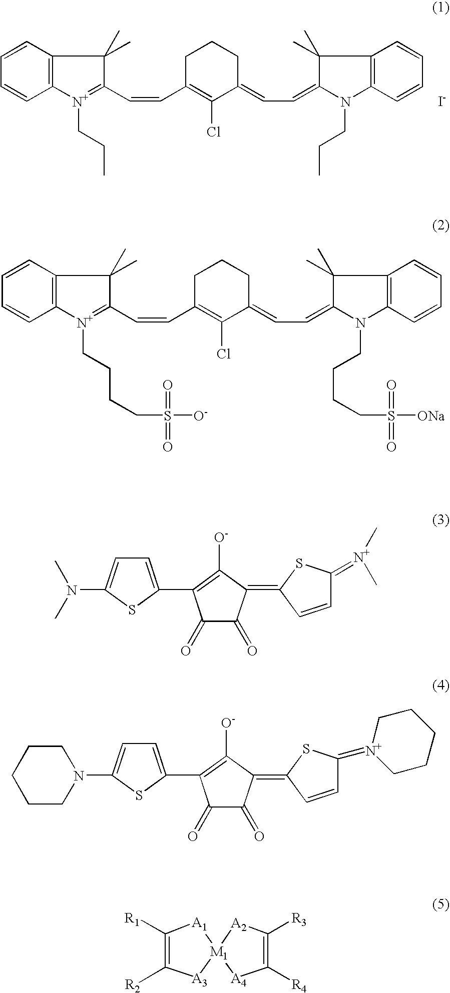

where M₁ is a transition metal, R₁, R₂, R₃, and R₄ are alkyl or aryl groups with or without halo substituents, and A₁, A₂, A₃, and A₄ can be S, NH, or Se;

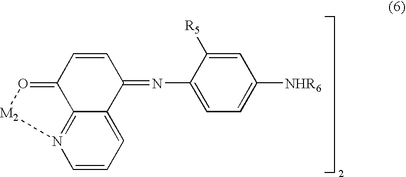

where M₂ is Ni or Cu and R₅ and R₆ are aryl or alkyl groups with or without halo substituents.

Additional examples of radiation absorbing compounds can be found in “Infrared Absorbing Dyes”, Matsuoka, Masaru, ed., Plenum Press (1990) (ISBN 0-30643478-4) and “Near-Infrared Dyes for High Technology Applications”, Daehne, S.; Resch-Genger, U.; Wolfbeis, O., Ed., Kluwer Academic Publishers (ISBN 0-7923-5101-0), both incorporated herein by reference.

The radiation absorbing compound can be about 0.2 wt % to 5 wt % of the coating layer, about 0.2 wt % to 2 wt % of the coating layer, and about 0.2 wt % to 0.6 wt % of the coating layer.

As used herein, the term “activator” is a substance that reacts with a color former, causing the color former to alter its chemical structure and change or acquire color.

The activator can include a compound that has an acid such as, but not limited to, a Lewis acid, has a functionality such as a complexed transition metal, metal salt, phenolic compound, and combinations thereof, and can be reactive with leuco dyes with or without introduction of energy in the form of light and/or heat.

In one embodiment, the activator can be a metal salt of an aromatic carboxylic acid. The metal of the metal salt can include, but is not limited to, transition metals such as zinc, tin, nickel, iron, and other transition metals. In one embodiment, the metal salt activator can be a zinc salt of an aromatic carboxylic acid. Other metal salt activators include zinc salicylate, tin salicylate, zinc 2-hydroxy naphthoate, 3,5-di-α-methylbenzyl zinc salicylate, metal salts of rhodanate, xanthate, aluminate, titanate, and zirconate, and mixtures thereof.

The activator can include, but is not limited to, a phenolic resin, zinc chloride bisphenol, hydroxybenzoate, amidophenol, anilides with hydroxyl groups, and benzoamides with hydroxyl groups including N-(4-Hydroxyphenyl)acetamide, 2-acetamidophenol, 3-acetamidophenol, salicylanilide, p-hydroxybenzamide, p-hydroxyphenyl acetamide, 3-hydroxy-2-napthanilide, o-hydroxybenzanilide, 4-hydroxyphenyl sulfone, 2,4′-dihydroxydiphenyl sulfone, Bis(4-hydroxy-3-allylphenyl)sulfone, 2,2′,5,5′-Tetrahydroxy diphenyl sulfone, 4-hydroxyphenyl-4′-isopropoxyphenly sulfone, 2,2-Bis(4-hydroxyphenyl)propane, and combinations thereof.

The activator can be about 2 wt % to 20 wt % of the coating layer, about 2 wt % to 15 wt % of the coating layer, and about 2 wt % to 10 wt % of the coating layer.

Various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas), and other known biocides.

Surfactants can also be present, such as, but not limited to, silicon based surfactants (e.g., Foamblast®), alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, such surfactants can be about 0.5 wt % to 5 wt % of the coating layer, about 0.5 wt % to 2.5 wt % of the coating layer, and about 0.5 wt % to 1 wt % of the coating layer.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### EXAMPLE 1

Table 1 includes an exemplary embodiment of a formulation of a coating layer.

TABLE 1

| | Wt % | Calc. Mass |
|---|---|---|
| Lacquer MV5231 (No SF) | 49.80 | 24.900 |
| SDP | 3.23 | 1.615 |
| Pergfast 201 (1% 780) | 4.14 | 2.070 |
| D-8/IR780 (40%) | 1.75 | 0.875 |
| D8 | 3.94 | 1.970 |
| m-T/715 Alloy (50/50) | 1.86 | 0.930 |
| YSR | 2.39 | 1.195 |
| Foamblast | 1.50 | 0.750 |
| Irgacure-1300 | 6.39 | 3.195 |
| Dupont Vazo 68WSP | 1.00 | 0.500 |
| BK400 Alloy RK025-60 | 25.00 | 12.500 |
| | 101.00 | 50.5 |

### EXAMPLE 2

Table 2 includes an exemplary embodiment of a formulation of a coating layer.

TABLE 2

| | Wt % | Calc. Mass |
|---|---|---|
| Lacquer MV5231 (No SF) | 49.80 | 24.900 |
| SDP | 3.23 | 1.615 |
| Pergfast 201 (1% 780) | 4.14 | 2.070 |
| D-8/IR780 (40%) | 1.75 | 0.875 |
| D8 | 3.94 | 1.970 |
| m-T/715 Alloy (50/50) | 1.86 | 0.930 |
| YSR | 2.39 | 1.195 |
| Foamblast | 1.50 | 0.750 |
| Irgacure-1300 | 6.39 | 3.195 |
| Dupont Vazo 68WSP | 2.00 | 1.000 |
| BK400 Alloy RK025-60 | 25.00 | 12.500 |
| | 102.00 | 51.0 |

### EXAMPLE 3

Table 3 includes an exemplary embodiment of a formulation of a coating layer.

TABLE 3

| | Wt % | Calc. Mass |
|---|---|---|
| Lacquer MV5231 (No SF) | 49.80 | 24.900 |
| SDP | 3.23 | 1.615 |
| Pergfast 201 (1% 780) | 4.14 | 2.070 |
| D-8/IR780 (40%) | 1.75 | 0.875 |
| D8 | 3.94 | 1.970 |
| m-T/715 Alloy (50/50) | 1.86 | 0.930 |
| YSR | 2.39 | 1.195 |
| Foamblast | 1.50 | 0.750 |
| Irgacure-1300 | 6.39 | 3.195 |
| Dupont Vazo 68WSP | 3.00 | 1.500 |
| BK400 Alloy RK025-60 | 25.00 | 12.500 |
| | 103.00 | 51.5 |

It should be noted that ratios; concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above-described embodiments. All such modifications and variations are intended to be included herein within the scope of this disclosure and protected by the following claims.

At least the following is claimed:

1. A coating layer comprising:
a UV curable free radical matrix, a thermal radical initiator, a color former, an activator, and a radiation-absorbing compound.

2. The coating layer of claim 1, wherein the thermal radical initiator is selected: azo compounds, peroxide compounds, and combinations thereof.

3. The coating layer of claim 2, wherein the azo compound is selected from: 2,2′-azo (bisisobutyronitrile), 1,1′-diphenyl-1,1′-diacetoxyazoethane, and combinations thereof.

4. The coating layer of claim 2, wherein the peroxide compound is selected from: diacyl peroxides, alkyl hydroperoxides, esters of diacyl peroxides, esters of alkyl hydroperoxides, peroxyesters, persulfates, and combinations thereof.

5. The coating layer of claim 1, wherein the UV curable free radical matrix is a multifunctional monomer.

6. The coating layer of claim 1, wherein the UV curable free radical matrix is a multifunctional monomer, and the thermal radical initiator is selected: azo compounds, peroxide compounds, and combinations thereof.

7. The coating layer of claim 1, wherein the thermal radical initiator is selected from a compound that decomposes at temperatures of about 40 to 110° C.

8. An image recording medium comprising:
a substrate having a coating layer disposed thereon, wherein the coating layer includes: a UV curable free radical matrix, a thermal radical initiator, a color former, an activator, and a radiation-absorbing compound.

9. The image recording medium of claim 8, wherein the substrate is selected from a paper medium, a transparency, a compact disk (CD), and a digital video disk (DVD).

10. The image recording medium of claim 8, wherein the substrate is selected from a CD-R/RW/ROM and DVD-R/RW/ROM.

11. The image recording medium of claim 8, wherein the thermal radical initiator is selected: azo compounds, peroxide compounds, and combinations thereof.

12. The image recording medium of claim 8, wherein the thermal radical initiator is selected from a compound that decomposes at temperatures of about 50 to 110° C.

13. A method for preparing an image recording medium, the method comprising:
providing a UV curable free radical matrix, a thermal radical initiator, a color former, an activator, and a radiation-absorbing compound;
mixing the matrix, the thermal radical initiator, the radiation absorbing compound, the activator, and the color former to form a direct imaging material; and
disposing the direct imaging material onto a substrate.

14. The method of claim 13, wherein the substrate is selected from a paper media, a transparency, a compact disk (CD), and a digital video disk (DVD).

15. The method of claim 13, wherein the substrate is selected from a CD-R/RW/ROM and DVD-R/RW/ROM.

16. The method of claim 13, wherein the thermal radical initiator is selected:
azo compounds, peroxide compounds, and combinations thereof.

17. The method of claim 16, wherein the azo compound is selected from: 2,2′-azo (bisisobutyronitrile), 1,1′-diphenyl-1,1′-diacetoxyazoethane, and combinations thereof.

18. The method of claim 16, wherein the peroxide compound is selected from: diacyl peroxides, alkyl hydroperoxides, esters of diacyl peroxides, esters of alkyl hydroperoxides, peroxyesters, persulfates, and combinations thereof.

19. The method of claim 16, wherein the thermal radical initiator is selected from a compound that decomposes at temperatures of about 60 to 110° C.

20. An image recording medium made by the method of claim 13.
